(19) United States
(12) Patent Application Publication
(10) Pub. No.: US 2020/0258397 A1
(43) Pub. Date: Aug. 13, 2020

(54) METHOD AND DEVICE FOR TRANSMITTING FLIGHT INFORMATION OF UNMANNED AERIAL VEHICLE, BASE STATION, AND CORE NETWORK DEVICE

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 16/864,722

(22) Filed: May 1, 2020

Related U.S. Application Data
(63) Continuation of application No. PCT/CN2017/109137, filed on Nov. 2, 2017.

(51) Int. Cl. G08G 5/00; H04W 36/32; H04W 4/40; B64C 39/02

(52) U.S. Cl. CPC G08G 5/0013; G08G 5/0039; B64C 39/024; H04W 36/32; H04W 4/40; G08G 5/0069

(57) ABSTRACT

The present disclosure relates to a method and a device for transmitting flight information of an unmanned aerial vehicle, a base station, and a core network device. The method for transmitting the flight information of an unmanned aerial vehicle can include acquiring a flight path of the unmanned aerial vehicle from an unmanned aerial vehicle management platform, and sending flight information of the unmanned aerial vehicle to a base station having a demand for the flight information of the unmanned aerial vehicle, the flight information being obtained based on the flight path. A base station serving the unmanned aerial vehicle can acquire the flight information of the unmanned aerial vehicle, thus helping the base station to improve the mobility of the unmanned aerial vehicle based on the flight path.

### CROSS-REFERENCE TO RELATED APPLICATIONS

This application is a Continuation Application of PCT Application No. PCT/CN2017/109137, filed on Nov. 2, 2017, the entire contents is incorporated herein by reference.

### TECHNICAL FIELD

The present disclosure relates to the technical field of wireless communications, and in particular, to a method and a device for transmitting flight information of an unmanned aerial vehicle, a base station, and a core network device.

### BACKGROUND

Unmanned Aerial Vehicles (UAVs) have been applied to some specific scenes to perform tasks such as aerial photography, unmanned detection and reconnaissance, measurement and surveying, highway surveying, city planning, ecological environmental monitoring, scientific investigation, oil exploration, aerial remote sensing, frontier patrol, forest fire prevention, disaster assessment, and the like.

In order to further expand the application range of the unmanned aerial vehicle, the 3rd Generation Partnership Project (3GPP) proposes a study that services meeting the requirements for the unmanned aerial vehicle provided by the cellular network become more standardized in a discussion of the Project of “enhanced support of unmanned aerial vehicles,” and the cellular network is considered to determine a flight path of the unmanned aerial vehicle in advance, so that it is helpful to improve mobility of the unmanned aerial vehicle, for example, improving the success rate and speed rate of handover.

### SUMMARY

Embodiments of the present disclosure can provide a method and a device for transmitting flight information of an unmanned aerial vehicle, a base station, and a core network device. Embodiments can enable a base station providing services for the unmanned aerial vehicle to acquire a base station to which the unmanned aerial vehicle as flying may access according to a flight path, thereby facilitating the base station to improve mobility of the unmanned aerial vehicle based on the flight path.

According to a first aspect of the present disclosure, a method for transmitting flight information of an unmanned aerial vehicle that can be applied to a core network device, is provided. The method can include acquiring a flight path of the unmanned aerial vehicle from an unmanned aerial vehicle management platform, and sending flight information of the unmanned aerial vehicle to a base station having a demand for the flight information of the unmanned aerial vehicle, the flight information being obtained based on the flight path.

In one embodiment, the flight information includes a flight path of the unmanned aerial vehicle, or the flight information includes a base station list corresponding to the unmanned aerial vehicle. An accessible base station of the unmanned aerial vehicle on the flight path can be recorded in the base station list.

Acquiring the flight path of the unmanned aerial vehicle from the unmanned aerial vehicle management platform can include receiving the flight path of the unmanned aerial vehicle sent by the unmanned aerial vehicle management platform.

Further, acquiring the flight path of the unmanned aerial vehicle from the unmanned aerial vehicle management platform can also include sending a first request message to the unmanned aerial vehicle management platform, wherein the first request message carries identification information of the unmanned aerial vehicle, and receiving the flight path of the unmanned aerial vehicle returned by the unmanned aerial vehicle management platform based on the first request message.

In one embodiment, sending the flight information of the unmanned aerial vehicle to the base station having a demand for the flight information of the unmanned aerial vehicle can include sending the flight information of the unmanned aerial vehicle to a currently accessed base station of the unmanned aerial vehicle and/or an accessible base station of the unmanned aerial vehicle. The accessible base station of the unmanned aerial vehicle is a base station capable to be accessed when the unmanned aerial vehicle flies based on the flight path.

In one embodiment, sending the flight information of the unmanned aerial vehicle to the base station having a demand for the flight information of the unmanned aerial vehicle can include receiving a second request message sent by the base station, wherein the second request message carries identification information of the unmanned aerial vehicle, and returning the flight information corresponding to the identification information of the unmanned aerial vehicle to the base station sending the second request message.

According to a second aspect of embodiments of the present disclosure, a method for transmitting flight information of an unmanned aerial vehicle, which is applied to a base station, is provided. The method can include acquiring flight information corresponding to the unmanned aerial vehicle from a core network device, and determining a next accessible base station to which the unmanned aerial vehicle can be handed over, based on the flight information corresponding to the unmanned aerial vehicle.

In one embodiment, acquiring flight information corresponding to the unmanned aerial vehicle from the core network device can include sending a second request message to the core network device. The second request message carries identification information of the unmanned aerial vehicle. Further, it can include receiving flight information corresponding to the identification information of the unmanned aerial vehicle returned by the core network device based on the second request message.

Additionally, determining the next accessible base station to which the unmanned aerial vehicle is handed over, based on the flight information corresponding to the unmanned aerial vehicle, can include sending a third request message for acquiring base station location information to an adjacent base station if the flight information includes a flight path of the unmanned aerial vehicle, and receiving the base station location information returned by the adjacent base station based on the third request message. Further, it can include determining a base station with the base station location information matched with the flight path as the next accessible base station to which the unmanned aerial vehicle can be handed over.

Determining the next accessible base station to which the unmanned aerial vehicle can be handed over, based on the flight information corresponding to the unmanned aerial vehicle, can also include, if the flight information has a base station list corresponding to the unmanned aerial vehicle, determining the next accessible base station to which the unmanned aerial vehicle can be handed over based on the accessible base station recorded in the base station list.

According to a third aspect of embodiments of the present disclosure, a device for transmitting flight information of an unmanned aerial vehicle, which is applied to a core network device, is provided. The device can include a first acquisition module that is configured to acquire a flight path of the unmanned aerial vehicle from an unmanned aerial vehicle management platform, and a first sending module that is configured to send flight information of the unmanned aerial vehicle to a base station having a demand for the flight information of the unmanned aerial vehicle, the flight information being obtained based on the flight path.

In one embodiment, the flight information includes the flight path of the unmanned aerial vehicle, or the flight information includes a base station list corresponding to the unmanned aerial vehicle, and an accessible base station of the unmanned aerial vehicle on the flight path is recorded in the base station list.

The first acquisition module can include a first receiving sub-module that is configured to receive the flight path of the unmanned aerial vehicle sent by the unmanned aerial vehicle management platform.

In another embodiment, the first acquisition module can include a first sending sub-module that is configured to send a first request message to the unmanned aerial vehicle management platform, wherein the first request message carries identification information of the unmanned aerial vehicle and a second receiving sub-module that is configured to receive the flight path of the unmanned aerial vehicle returned by the unmanned aerial vehicle management platform based on the first request message.

Further, the first sending module can include second sending sub-module that is configured to send the flight information of the unmanned aerial vehicle to a currently accessed base station of the unmanned aerial vehicle and/or an accessible base station of the unmanned aerial vehicle, wherein the accessible base station of the unmanned aerial vehicle is a base station capable to be accessed when the unmanned aerial vehicle flies based on the flight path.

In one embodiment, the first sending module can include a third receiving sub-module configured to receive a second request message sent by the base station, wherein the second request message carries identification information of the unmanned aerial vehicle, and a third sending sub-module configured to return the flight information corresponding to the identification information of the unmanned aerial vehicle to the base station sending the second request message.

According to a fourth aspect of embodiments of the present disclosure, a device for transmitting flight information of an unmanned aerial vehicle, applied to a base station, is provided. The device can include a second acquisition module configured to acquire a base station list corresponding to the unmanned aerial vehicle from a core network device, and a determination module configured to return flight information corresponding to identification information of the unmanned aerial vehicle to a base station sending a second request message.

In one embodiment, the second acquisition module can include a fourth sending sub-module configured to send the second request message to the core network device, wherein the second request message carries the identification information of the unmanned aerial vehicle, and a fourth receiving sub-module configured to receive the flight information corresponding to the identification information of the unmanned aerial vehicle returned by the core network device based on the second request message.

In one embodiment, the determination module can include a fifth sending sub-module configured to send a third request message for acquiring base station location information to an adjacent base station if the flight information comprises a flight path of the unmanned aerial vehicle, a fifth receiving sub-module configured to receive the base station location information returned by the adjacent base station based on the third request message, and a first determination sub-module configured to determine a base station with the base station location information matched with the flight path as a next accessible base station to which the unmanned aerial vehicle can be handed over.

In one embodiment, the determination module includes:

a second determination sub-module configured to determine, the next accessible base station to which the unmanned aerial vehicle can be handed over, based on accessible base stations recorded in the base station list if the flight information includes the base station list corresponding to the unmanned aerial vehicle.

According to a fifth aspect of embodiments of the present disclosure, a core network device is provided. The core network device can include a processor and a memory for storing processor-executable instructions. The processor can be configured to acquire a flight path of the unmanned aerial vehicle from an unmanned aerial vehicle management platform, and send flight information of the unmanned aerial vehicle to a base station having a demand for the flight information of the unmanned aerial vehicle, the flight information being obtained based on the flight path.

According to a sixth aspect of embodiments of the present disclosure, a base station is provided. The base station can include a processor and a memory for storing processor-executable instructions. The processor can be configured to acquire flight information corresponding to an unmanned aerial vehicle from a core network device, and determine the next accessible base station to which the unmanned aerial vehicle can be handed over, based on the flight information corresponding to the unmanned aerial vehicle.

According to a seventh aspect of embodiments of the present disclosure, a non-transitory computer readable storage medium having computer instructions stored thereon is provided. The instructions are executed by a processor to implement the steps of acquiring a flight path of the unmanned aerial vehicle from an unmanned aerial vehicle management platform, and sending flight information of the unmanned aerial vehicle to a base station having a demand for the flight information of the unmanned aerial vehicle, the flight information being obtained based on the flight path.

According to an eighth aspect of embodiments of the present disclosure, a non-transitory computer readable storage medium having computer instructions stored thereon is provided, and the instructions are executed by a processor to implement the steps of acquiring flight information corresponding to the unmanned aerial vehicle from a core network device, and determining a next accessible base station to which the unmanned aerial vehicle can be handed over, based on the flight information corresponding to the unmanned aerial vehicle.

The technical solution provided by the embodiments of the present disclosure can have beneficial effects. For example, the core network device can acquire the flight path of the unmanned aerial vehicle from the unmanned aerial vehicle management platform, and send the flight information to the base station having a demand for flight information of the unmanned aerial vehicle, for example, to a currently accessed base station of the unmanned aerial vehicle or an accessible base station of the unmanned aerial vehicle, so that the base station when being accessed by the unmanned aerial vehicle can carry out resource negotiation with next base station that probably serves the unmanned aerial vehicle in advance, thereby facilitating the base station to improve the mobility of the unmanned aerial vehicle based on the flight path.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and together with the description, serve to explain the principles of the invention.

FIG. 1A is a flowchart showing a method for transmitting flight information of an unmanned aerial vehicle, according to an exemplary embodiment.

FIG. 1B is a block diagram showing a method for transmitting flight information of an unmanned aerial vehicle according to an exemplary embodiment.

FIG. 2 is a first flowchart showing interaction between communication entities in a method for transmitting flight information of an unmanned aerial vehicle according to an exemplary embodiment.

FIG. 3 is a second flowchart showing interaction between communication entities in another method for transmitting flight information of an unmanned aerial vehicle according to an exemplary embodiment.

FIG. 4 is a third flowchart showing interaction between communication entities in another method for transmitting flight information of an unmanned aerial vehicle according to an exemplary embodiment.

FIG. 5 is a flowchart showing a method for transmitting flight information of an unmanned aerial vehicle, according to an exemplary embodiment.

FIG. 6 is a flowchart showing another method for transmitting flight information of an unmanned aerial vehicle, according to an exemplary embodiment.

FIG. 7 is a block diagram showing a device for transmitting flight information of an unmanned aerial vehicle according to an exemplary embodiment.

FIG. 8 is a block diagram showing another device for transmitting flight information of an unmanned aerial vehicle according to an exemplary embodiment.

FIG. 9 is a block diagram showing a device for transmitting flight information of an unmanned aerial vehicle according to an exemplary embodiment.

FIG. 10 is a block diagram showing another device for transmitting flight information of an unmanned aerial vehicle according to an exemplary embodiment.

FIG. 11 is a block diagram showing a transmission device suitable for flight information of an unmanned aerial vehicle according to an exemplary embodiment.

### DETAILED DESCRIPTION

Exemplary embodiments will be described in detail herein, examples of which are illustrated in the drawings. When the following description refers to the drawings, the same numbers in different drawings represent the same or similar elements, unless otherwise indicated. The implementations described in the following exemplary embodiments do not represent all implementations consistent with the present disclosure. Instead, the embodiments are merely examples of devices and methods consistent with aspects of the present disclosure as described in detail in the appended claims.

In this disclosure, the unmanned aerial vehicle can be a cellular network unmanned aerial vehicle that accesses to a cellular network.

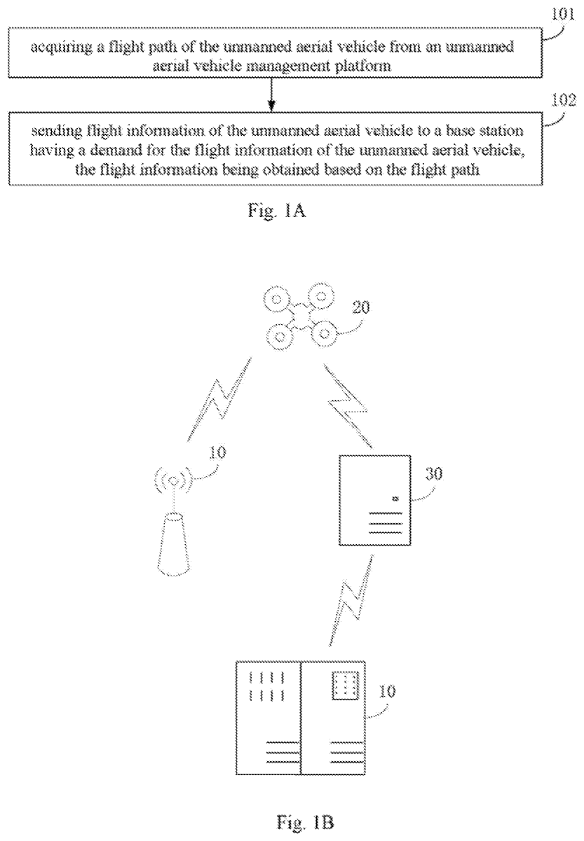

FIG. 1A is a flowchart showing a method for transmitting flight information of an unmanned aerial vehicle, according to an exemplary embodiment, and FIG. 1B is a block diagram showing a method for transmitting flight information of an unmanned aerial vehicle according to an exemplary embodiment. The method for transmitting the flight information of the unmanned aerial vehicle can be applied to a core network device, and as shown in FIG. 1A, the method for transmitting the flight information of the unmanned aerial vehicle includes following steps 101-102.

In step 101, a flight path of an unmanned aerial vehicle is acquired from an unmanned aerial vehicle management platform. In one embodiment, the unmanned aerial vehicle management platform may be understood as a platform for controlling and managing the unmanned aerial vehicle, for example, a flight path of the unmanned aerial vehicle may be set through the unmanned aerial vehicle management platform, such that the unmanned aerial vehicle flies according to a planned flight route. After the unmanned aerial vehicle management platform sets the flight path of the unmanned aerial vehicle, the flight path may be directly sent to the core network device, as such, the core network device may receive the flight path of the unmanned aerial vehicle sent by the unmanned aerial vehicle management platform.

In one embodiment, the core network device may further actively send a first request message to the unmanned aerial vehicle management platform, and the first request message carries identification information of the unmanned aerial vehicle, to request the unmanned aerial vehicle management platform to inform the flight path of the unmanned aerial vehicle. If the unmanned aerial vehicle management platform has the flight path corresponding to the unmanned aerial vehicle, the flight path corresponding to the unmanned aerial vehicle may be sent to the core network device after receiving the first request message, and if the unmanned aerial vehicle management platform does not have the flight path corresponding to the unmanned aerial vehicle, the core network device may be informed that the flight path of the unmanned aerial vehicle is not set.

In one embodiment, when a flight mode of the unmanned aerial vehicle is generally a fixed mode, the unmanned aerial vehicle management platform may preset the flight path of the unmanned aerial vehicle. When the flight mode of the unmanned aerial vehicle is a dynamic mode, that is, when the unmanned aerial vehicle is remotely controlled in real time by the user through a controller, the unmanned aerial vehicle management platform may not preset the flight path.

In step 102, the flight information of the unmanned aerial vehicle is sent to a base station having a demand for the flight information of the unmanned aerial vehicle, and the flight information is obtained based on the flight path. The flight information may include the flight path of the unmanned aerial vehicle and the identification information of the unmanned aerial vehicle. Further, the flight information may include a base station list corresponding to the unmanned aerial vehicle, and an accessible base station of the unmanned aerial vehicles on the flight path is recorded in the base station list.

In one embodiment, the base station having a demand for flight information of the unmanned aerial vehicle may be understood as a base station that requests the flight information of the unmanned aerial vehicle. Further, the base station having a demand for flight information of the unmanned aerial vehicle may be understood as a currently accessed base station of the unmanned aerial vehicle and/or an accessible base station to which the unmanned aerial vehicle as flying may access based on the flight path.

The core network device may directly send the flight information to a base station to which the unmanned aerial vehicle currently accesses and/or an accessible base station of the unmanned aerial vehicle on the flight path, and in one embodiment, as receiving a second request message sent by the base station, the core network device may further send the base station list to the base station sending the second request message.

In one embodiment, after the core network device sends the base station list to a base station, the base station when being accessed by the unmanned aerial vehicle may determine a next base station that may serve the unmanned aerial vehicle according to the base station list, and further perform resource interaction with the possible next base station. For example, the base station list may indicate that the unmanned aerial vehicle may sequentially access to the base station 1, the base station 2, the base station 3, and the base station 4, and then the base station 1 when being accessed by the unmanned aerial vehicle may determine that the unmanned aerial vehicle may be handed over to the base station 2 in advance, so that information of the unmanned aerial vehicle, such as context information of the unmanned aerial vehicle, may be interacted with the base station 2 in advance, thereby providing a better mobility for the unmanned aerial vehicle.

As shown in the example of FIG. 1B, an unmanned aerial vehicle management platform 10, an unmanned aerial vehicle 20, a core network device 30, at least one base station 40, and the like can be included. After setting a flight path of the unmanned aerial vehicle 20, the unmanned aerial vehicle management platform 10 may send the flight path to the core network device 30. The core network device 30 based on the flight path may determine an accessible base station that the unmanned aerial vehicle 20 may pass through and access when flying according to the flight path, and send the accessible base station to the base station 40. The base station 40 may determine the next accessible base station of the unmanned aerial vehicle based on the accessible base station when the unmanned aerial vehicle 20 accesses to the base station 40, thereby performing resource negotiation and preparing for handover in advance, and improving mobility performance of the unmanned aerial vehicle 20.

In this embodiment with the foregoing steps 101 to 103, the core network device can acquire the flight path of the unmanned aerial vehicle from the unmanned aerial vehicle management platform. The core network device can then send the flight information to the base station having a demand for flight information of the unmanned aerial vehicle, for example, to a currently accessed base station of the unmanned aerial vehicle or an accessible base station of the unmanned aerial vehicle, so that the base station when being accessed by the unmanned aerial vehicle can carry out the resource negotiation with the next base station that probably serves the unmanned aerial vehicle in advance, thereby facilitating the base station to improve the mobility of the unmanned aerial vehicle based on the flight path. Subsequent embodiments will be referenced for specifically how to transmit the flight information of the unmanned aerial vehicle.

The technical solutions provided by the embodiments of the present disclosure are described below with specific embodiments.

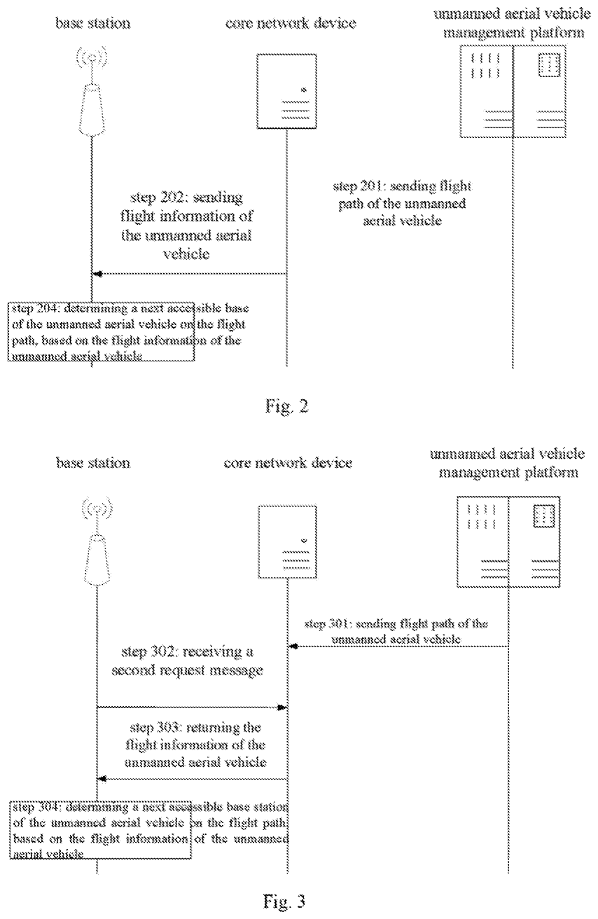

FIG. 2 is a first flowchart showing interaction between communication entities in a method for transmitting flight information of an unmanned aerial vehicle according to an exemplary embodiment. In this embodiment, by using the above method provided by the embodiments of the present disclosure, an example is exemplarity shown in which interaction between communication entities is performed, so that a base station can acquire flight information of an unmanned aerial vehicle. As shown in FIG. 2, the method can include the following steps.

In step 201, the unmanned aerial vehicle management platform sends the flight path of the unmanned aerial vehicle to the core network device. In one embodiment, the unmanned aerial vehicle management platform may send the flight path of the unmanned aerial vehicle to the core network connected thereby after the flight path for the unmanned aerial vehicle is set.

In step 202, the core network device sends the flight information of the unmanned aerial vehicle to the base station. In one embodiment, the core network device may directly send the flight path of the unmanned aerial vehicle and the identification information of the unmanned aerial vehicle to the base station. Further, based on a coverage area of each of the base stations and the flight path of the unmanned aerial vehicle, the core network device may further determine the accessible base stations when the unmanned aerial vehicle flies according to the flight path. In one embodiment, the accessible base station may be understood as being accessible when the unmanned aerial vehicle flies based on the flight path, for example, the flight path of the unmanned aerial vehicle passes through the coverage area including the base station 1, the base station 2, the base station 3, the base station 4, and the base station 5, and then the accessible base stations may be the base station 1, the base station 2, the base station 3, the base station 4, and the base station 5, however, the unmanned aerial vehicle may only access to the base station 1, the base station 3, and the base station 5 during the flight process, that is, the accessible base station is a base station that the unmanned aerial vehicle may, but not necessarily access. In one embodiment, the core network device may form a base station list including accessible base stations.

The core network device may send a base station list composed of accessible base stations and the identification information of the unmanned aerial vehicle to the base station having a demand for the flight information of the unmanned aerial vehicle Further, the core network device may send the base station list to each of the accessible base stations and the base station to which the unmanned aerial vehicle currently access through an interface with the base station, such as an S1 interface.

In step 203, the base station determines a next accessible base station of the unmanned aerial vehicle on the flight path based on the flight information of the unmanned aerial vehicle. In this embodiment, an implementation for transmitting the flight path of the unmanned aerial vehicle is disclosed. The unmanned aerial vehicle management platform may send the flight path to the core network device after setting the flight path of the unmanned aerial vehicle, and the core network device sends the flight information to the base station having a demand for the flight information, so that the base station may determine the next base station that probably serves the unmanned aerial vehicle in advance based on the flight information, performs resource negotiation with the next base station in advance, and thus provides a better mobility for the unmanned aerial vehicle.

FIG. 3 is a second flowchart showing interaction between communication entities in another method for transmitting flight information of an unmanned aerial vehicle according to an exemplary embodiment. In this embodiment, by using the above method provided by the embodiments of the present disclosure, an example is exemplarity shown in which interaction between communication entities is performed, so that a base station can acquire flight information of an unmanned aerial vehicle, and as shown in FIG. 3, the method includes the following steps.

In step 301, the unmanned aerial vehicle management platform sends the flight path of the unmanned aerial vehicle to the core network device.

In step 302, the core network device receives a second request message sent by the base station. In one embodiment, when it is determined that the base station serves for the unmanned aerial vehicle, for example, when the unmanned aerial vehicle accesses to the base station, the base station may actively send a second request message to the core network device for requesting the core network device to inform the base station to which the unmanned aerial vehicle can access. The second request message may carry identification information of the unmanned aerial vehicle as requested.

In step 303, the core network device returns the flight information of the unmanned aerial vehicle to the base station sending the second request message. In one embodiment, the core network device may send a base station list to the base station sending the second request message through an interface with the base station, such as an S1 interface.

In step 304, the base station determines a next accessible base station of the unmanned aerial vehicle on the flight path based on the flight information of the unmanned aerial vehicle. In this embodiment, an implementation for sending a flight path of an unmanned aerial vehicle is disclosed. The unmanned aerial vehicle management platform may send the flight path to the core network device after setting the flight path of the unmanned aerial vehicle, the core network device may return flight information of the unmanned aerial vehicle to the base station after receiving a second request message of the base station, so that the base station may determine the next base station that probably serves the unmanned aerial vehicle in advance based on the flight information, performs resource negotiation with the next base station in advance, and thus provides a better mobility for the unmanned aerial vehicle.

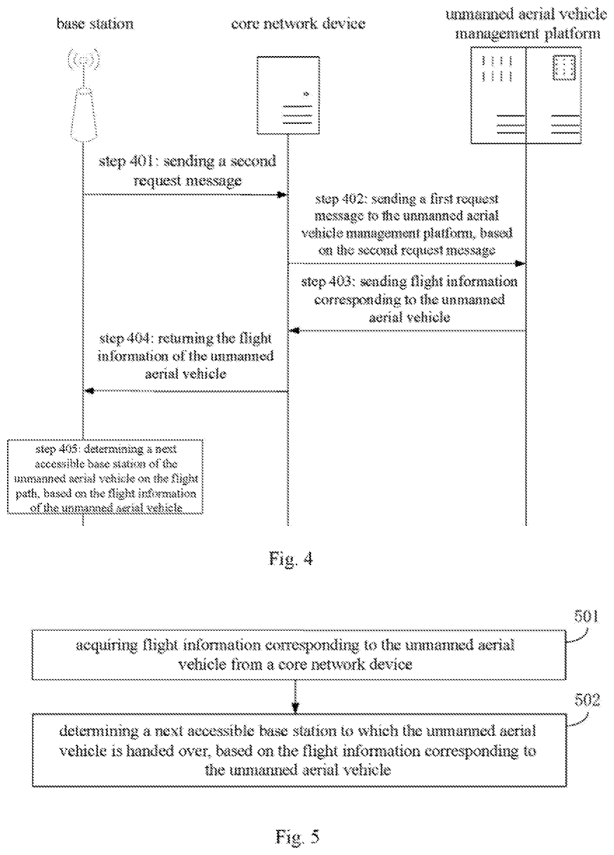

FIG. 4 is a third flowchart showing interaction between communication entities in another method for transmitting flight information of an unmanned aerial vehicle according to an exemplary embodiment; in this embodiment, by using the above method provided by the embodiments of the present disclosure, an example is exemplarity shown in which interaction between communication entities is performed, so that a base station can acquire flight information of an unmanned aerial vehicle, and as shown in FIG. 4, the method includes the following steps.

In step 401, the base station sends a second request message to the core network device. In one embodiment, when it is determined that the base station serves for the unmanned aerial vehicle, for example, when the unmanned aerial vehicle accesses to the base station, the base station may actively send a second request message to the core network device for requesting the core network device to inform the base station to which the unmanned aerial vehicle can access. The second request message may carry identification information of the unmanned aerial vehicle.

In step 402, the core network device sends a first request message to the unmanned aerial vehicle management platform based on the second request message. In one embodiment, based on the identification information of the unmanned aerial vehicle in the second request message, the core network device sends a first request message to the unmanned aerial vehicle management platform, wherein the first request message carries the identification information of the unmanned aerial vehicle.

In step 403, the unmanned aerial vehicle management platform sends the flight path corresponding to the unmanned aerial vehicle to the core network device. In an embodiment, if the flight path corresponding to the unmanned aerial vehicle is not set in the unmanned aerial vehicle management platform, an indication information having no flight path of the unmanned aerial vehicle may be returned to the core network device, so that the core network device returns an indication information that the accessible base station of the unmanned aerial vehicle cannot be determined to the base station.

In step 404, the core network device returns the flight information of the unmanned aerial vehicle to the base station.

In step 405, the base station determines a next accessible base station of the unmanned aerial vehicle on the flight path based on the flight information of the unmanned aerial vehicle. A mode for transmitting a flight path of the unmanned aerial vehicle based on a request is disclosed. When the base station needs to acquire accessible base stations of the unmanned aerial vehicle, the base station actively sends a request to the core network device, and the core network device requests the unmanned aerial vehicle management platform, to avoid the core network device from sending the base station list to all the base stations, and signaling waste caused by that some of the base stations do not need the information.

FIG. 5 is a flowchart showing a method for transmitting flight information of an unmanned aerial vehicle, according to an exemplary embodiment. The method for transmitting flight information of the unmanned aerial vehicle can be applied to a base station, and includes the following steps as shown in FIG. 5.

In step 501, flight information corresponding to the unmanned aerial vehicle is acquired from the core network device. The base station may actively send a second request message to the core network device as requiring information of the accessible base stations of the unmanned aerial vehicle, and receive a base station list corresponding to the unmanned aerial vehicle, which is returned by the core network device based on the second request message. The core network device may also actively send the base station list corresponding to the unmanned aerial vehicle to the determined accessible base station, so that the base station may receive the base station list corresponding to the unmanned aerial vehicle sent by the core network device.

In step 502, a next accessible base station to which the unmanned aerial vehicle may handed over is determined based on the flight information corresponding to the unmanned aerial vehicle. The base station when being accessed by the unmanned aerial vehicle may determine the next accessible base station to which may be handed over based on the flight information of the unmanned aerial vehicle, and perform resource negotiation operation with the next accessible base station.

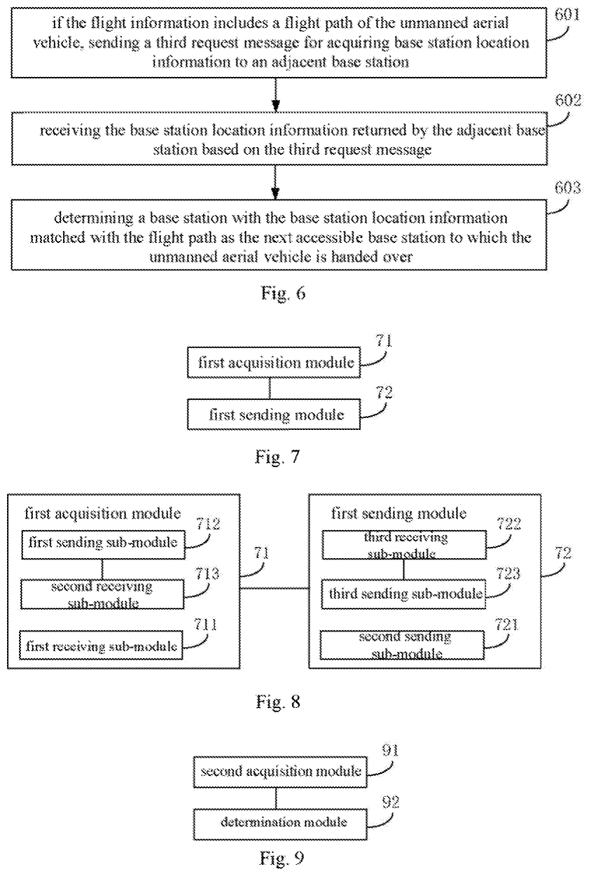

In one embodiment, when the flight information of the unmanned aerial vehicle includes the flight path of the unmanned aerial vehicle, the next accessible base station may be determined with reference to the embodiment shown in FIG. 6. When the flight information of the unmanned aerial vehicle includes the base station list corresponding to the unmanned aerial vehicle, the next accessible base station to which the unmanned aerial vehicle may be handed over may be determined directly based on the accessible base stations recorded in the base station list, for example, the accessible base station that is recorded in the base station list and adjacent to the current base station may be determined directly as the next accessible base station to which the unmanned aerial vehicle may be handed over.

In the example shown in FIG. 1B, an unmanned aerial vehicle management platform 10, an unmanned aerial vehicle 20, a core network device 30, at least one base station 40, and the like are included. After setting a flight path of the unmanned aerial vehicle 20, the unmanned aerial vehicle management platform 10 may send the flight path to the core network device 30. The core network device 30, based on the flight path, may determine an accessible base station that the unmanned aerial vehicle 20 may pass through and access when flying according to the flight path, and send the accessible base station to the base station 40. The base station 40 may determine a next accessible base station of the unmanned aerial vehicle based on the accessible base station when the unmanned aerial vehicle 20 accesses to the base station 40, thereby performing resource negotiation and preparing for handover in advance, and improving mobility performance of the unmanned aerial vehicle 20.

In this embodiment, through the steps 501 to 502, the base station may acquire the base station list corresponding to the unmanned aerial vehicle from the core network device, so as to provide a better mobility for the unmanned aerial vehicle.

FIG. 6 is a flowchart showing another method for transmitting flight information of an unmanned aerial vehicle, according to an exemplary embodiment. In this embodiment, by using the above method provided by the embodiments of the present disclosure, an illustrative description is made as an example of how the base station determines the next accessible base station when the flight information is the flight path of the unmanned aerial vehicle. As shown in FIG. 6, the method can include the following steps.

In step 601, if the flight information includes a flight path of the unmanned aerial vehicle, a third request message for acquiring base station location information is sent to an adjacent base station. The flight path may be composed of a plurality of coordinate points, and the base station when being accessed by the unmanned aerial vehicle may send a third request message to the adjacent base station, wherein the third request message is used for the base station to obtain the location information of its adjacent base station.

In step 602, the base station location information returned by the adjacent base station based on the third request message is received.

In step 603, the base station with a base station location information matched with the flight path is determined as a next accessible base station to which the unmanned aerial vehicle may be handed over. Based on a position relationship between the base station location information of the adjacent base station and the flight path, for example, a position identified when the flight path of the unmanned aerial vehicle passes through location information of the unmanned aerial vehicle, or a coverage area of the adjacent base station includes a part of the flight path of the unmanned aerial vehicle, the base station may determine which adjacent base stations match with the flight path of the unmanned aerial vehicle, and determine the matched base station as the next accessible base station to which the unmanned aerial vehicle may be handed over, the next accessible base station of the unmanned aerial vehicle is not limited to one.

This embodiment discloses how the base station determines the next accessible base station based on the flight path of the unmanned aerial vehicle, and then realizes that the currently accessed base station of the unmanned aerial vehicle may perform resource negotiation with the next accessible base station that probably serves the unmanned aerial vehicle next in advance, thereby helping the base station to improve the mobility of the unmanned aerial vehicle based on the flight path.

FIG. 7 is a block diagram of a device for transmitting flight information of an unmanned aerial vehicle, which is applied to a core network device. According to an exemplary embodiment, and as shown in FIG. 7, the device for transmitting flight information of the unmanned aerial vehicle can include a first acquisition module 71 that is configured to acquire a flight path of the unmanned aerial vehicle from an unmanned aerial vehicle management platform. Further, the device can include a first sending module 72 that is configured to send flight information of the unmanned aerial vehicle to a base station having a demand for the flight information of the unmanned aerial vehicle, the flight information being obtained based on the flight path.

FIG. 8 is a block diagram of another device for transmitting flight information of an unmanned aerial vehicle according to an exemplary embodiment. As shown in FIG. 8, and based on the embodiment shown in FIG. 7, in one embodiment, the flight information includes a flight path of the unmanned aerial vehicle, or the flight information includes a base station list corresponding to the unmanned aerial vehicle, and an accessible base station of the unmanned aerial vehicle on the flight path is recorded in the base station list.

In one embodiment, the first acquisition module 71 can include a first receiving sub-module 711, which is configured to receive the flight path of the unmanned aerial vehicle sent by the unmanned aerial vehicle management platform.

In an embodiment, the first acquisition module 71 can include first sending sub-module 712 that is configured to send a first request message to the unmanned aerial vehicle management platform, wherein the first request message carries identification information of the unmanned aerial vehicle, and a second receiving sub-module 713 that is configured to receive the flight path of the unmanned aerial vehicle returned by the unmanned aerial vehicle management platform based on the first request message.

The first sending module 72 can include a second sending sub-module 721 that is configured to send the flight information of the unmanned aerial vehicle to a currently accessed base station of the unmanned aerial vehicle and/or an accessible base station of the unmanned aerial vehicle, where the accessible base station of the unmanned aerial vehicle is a base station capable to be accessed when the unmanned aerial vehicle flies based on the flight path.

The first sending module 72 can also include a third receiving sub-module 722 that is configured to receive a second request message sent by the base station, where the second request message carries identification information of the unmanned aerial vehicle, and a third sending sub-module 723 that is configured to return the flight information corresponding to the identification information of the unmanned aerial vehicle to the base station sending the second request message.

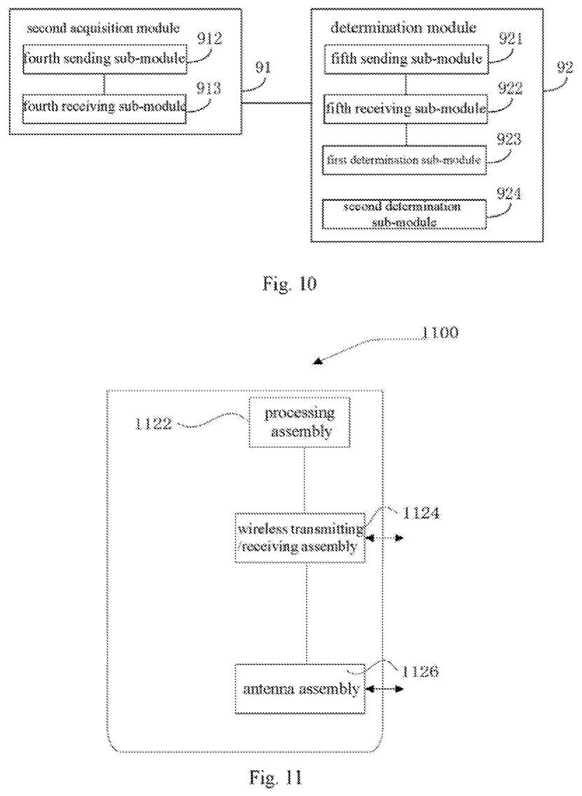

FIG. 9 is a block diagram of a device for transmitting flight information of an unmanned aerial vehicle, which is applied to a base station, according to an exemplary embodiment, and as shown in FIG. 9. The device for transmitting flight information of the unmanned aerial vehicle can include a second acquisition module 91 that is configured to acquire a base station list corresponding to the unmanned aerial vehicle from a core network device, and a determination module 92 that is configured to return flight information corresponding to identification information of the unmanned aerial vehicle to a base station sending a second request message.

FIG. 10 is a block diagram of another device for transmitting flight information of an unmanned aerial vehicle according to an exemplary embodiment. As shown in FIG. 10, and based on the embodiment shown in FIG. 9, in one embodiment. The second acquisition module 91 can include a fourth sending sub-module 911 that is configured to send the second request message to the core network device, where the second request message carries the identification information of the unmanned aerial vehicle, and a fourth receiving sub-module 912 that is configured to receive the flight information corresponding to the identification information of the unmanned aerial vehicle returned by the core network device based on the second request message.

In an embodiment, the determination module 92 can include a fifth sending sub-module 921 that is configured to send a third request message for acquiring base station location information to an adjacent base station if the flight information comprises a flight path of the unmanned aerial vehicle, a fifth receiving sub-module 922 that is configured to receive the base station location information returned by the adjacent base station based on the third request message, and a first determination sub-module 923 that is configured to determine a base station with the base station location information matched with the flight path as a next accessible base station to which the unmanned aerial vehicle can be handed over.

Further, the determination module 92 can include a second determination sub-module 924 that is configured to determine, if the flight information comprises a base station list corresponding to the unmanned aerial vehicle, the next accessible base station to which the unmanned aerial vehicle can be handed over is determined based on the accessible base stations recorded in the base station list.

With regard to the device in above embodiments, the specific manners in which each module performs operation have been described in detail in the embodiments related to the method, and will not be described in detail here.

FIG. 11 is a block diagram showing a transmission device suitable for flight information of an unmanned aerial vehicle according to an exemplary embodiment. The device 1100 may be provided as a base station or a core network device. Referring to FIG. 11, the device 1100 includes a processing assembly 1122, a wireless transmitting/receiving assembly 1124, an antenna assembly 1126, and a signal processing portion specific to the wireless interface, and the processing assembly 1122 may further include one or more processors.

When the device 1100 is a core network device, one of the processors in the processing component 1122 may be configured to perform the method for transmitting flight information of an unmanned aerial vehicle described in the first aspect mentioned above.

When the device 1100 is a base station, one of the processors in the processing component 1122 may be configured to perform the method of transmitting flight information of the unmanned aerial vehicle described in the second aspect mentioned above.

In an exemplary embodiment, a non-transitory computer readable storage medium including instructions is further provided. The instructions may be executed by the processing assembly 1122 of the device 1100 to perform the method described in the first or third aspect mentioned above. For example, the non-transitory computer readable storage medium may be a ROM, a Random Access Memory (RAM), a CD-ROM, a magnetic tape, a soft disk, an optical data storage device, and the like.

Other embodiments of the disclosure will be apparent to those skilled in the art from consideration of the specification and practice of the disclosure disclosed herein. This application is intended to cover any variations, uses, or adaptations of the disclosure following, in general, the principles of the disclosure and including such departures from the present disclosure as come within known or customary practice in the art to which the disclosure pertains. It is intended that the specification and examples be considered as exemplary only, with a true scope and spirit of the disclosure being indicated by the following claims.

It will be understood that the present disclosure is not limited to the precise arrangements that have been described above and shown in the drawings, and may be modified and changed without departing from the scope thereof. The scope of the present disclosure is limited only by the appended claims.

What is claimed is:

1. A method for transmitting flight information of an unmanned aerial vehicle that is applied to a core network device, the method comprising:
acquiring a flight path of the unmanned aerial vehicle from an unmanned aerial vehicle management platform;
obtaining flight information based on the flight path; and
sending the flight information of the unmanned aerial vehicle to a base station having a demand for the flight information of the unmanned aerial vehicle.

2. The method of claim 1, wherein the flight information further comprises:
the flight path of the unmanned aerial vehicle; or
a base station list corresponding to the unmanned aerial vehicle that includes an accessible base station of the unmanned aerial vehicle on the flight path.

3. The method of claim 1, wherein acquiring the flight path of the unmanned aerial vehicle from the unmanned aerial vehicle management platform further comprises:
receiving the flight path of the unmanned aerial vehicle sent by the unmanned aerial vehicle management platform.

4. The method of claim 1, wherein acquiring the flight path of the unmanned aerial vehicle from the unmanned aerial vehicle management platform further comprises:
sending a first request message to the unmanned aerial vehicle management platform that includes identification information of the unmanned aerial vehicle; and
receiving the flight path of the unmanned aerial vehicle returned by the unmanned aerial vehicle management platform in response to the first request message.

5. The method of claim 1, wherein sending the flight information of the unmanned aerial vehicle to the base station having a demand for the flight information of the unmanned aerial vehicle further comprises:
sending the flight information of the unmanned aerial vehicle to a currently accessed base station of the unmanned aerial vehicle and/or an accessible base station of the unmanned aerial vehicle, wherein the accessible base station of the unmanned aerial vehicle is a base station capable to be accessed when the unmanned aerial vehicle flies based on the flight path.

6. The method of claim 1, wherein sending the flight information of the unmanned aerial vehicle to the base station having a demand for the flight information of the unmanned aerial vehicle further comprises:
receiving a second request message sent by the base station that includes identification information of the unmanned aerial vehicle; and
returning the flight information corresponding to the identification information of the unmanned aerial vehicle to the base station sending the second request message.

7. A method for transmitting flight information of an unmanned aerial vehicle that is applied to a base station, the method comprising:
acquiring flight information corresponding to the unmanned aerial vehicle from a core network device; and
determining a next accessible base station to which the unmanned aerial vehicle is to be handed over based on the flight information corresponding to the unmanned aerial vehicle.

8. The method of claim 7, wherein acquiring flight information corresponding to the unmanned aerial vehicle from the core network device further comprises:
sending a second request message to the core network device that includes identification information of the unmanned aerial vehicle; and
receiving flight information corresponding to the identification information of the unmanned aerial vehicle returned by the core network device based on the second request message.

9. The method of claim 7, wherein determining the next accessible base station to which the unmanned aerial vehicle is to be handed over based on the flight information corresponding to the unmanned aerial vehicle further comprises:
if the flight information includes a flight path of the unmanned aerial vehicle, then sending a third request message for acquiring base station location information to an adjacent base station;
receiving the base station location information returned by the adjacent base station based in response to the third request message; and
determining a base station with the base station location information matched with the flight path as the next accessible base station to which the unmanned aerial vehicle is to be handed over.

10. The method of claim 7, wherein determining the next accessible base station to which the unmanned aerial vehicle to be handed over based on the flight information corresponding to the unmanned aerial vehicle further comprises:
if the flight information includes a base station list corresponding to the unmanned aerial vehicle, then determining the next accessible base station to which the unmanned aerial vehicle is handed over based on the accessible base station recorded in the base station list.

11. A device for transmitting flight information of an unmanned aerial vehicle that is applied to a core network device, the device comprising:
a first acquisition module that is configured to acquire a flight path of the unmanned aerial vehicle from an unmanned aerial vehicle management platform;
a first sending module that is configured to send flight information of the unmanned aerial vehicle to a base station having a demand for the flight information of the unmanned aerial vehicle, the flight information being obtained based on the flight path.

12. The device of claim 11, wherein the flight information further comprises the flight path of the unmanned aerial vehicle or a base station list corresponding to the unmanned aerial vehicle, and an accessible base station of the unmanned aerial vehicle on the flight path is recorded in the base station list.

13. The device of claim 11, wherein the first acquisition module further comprises:
a first receiving sub-module that is configured to receive the flight path of the unmanned aerial vehicle sent by the unmanned aerial vehicle management platform.

14. The device of claim 11, wherein the first acquisition module further comprises:
a first sending sub-module that is configured to send a first request message to the unmanned aerial vehicle management platform, wherein the first request message carries identification information of the unmanned aerial vehicle; and
a second receiving sub-module that is configured to receive the flight path of the unmanned aerial vehicle returned by the unmanned aerial vehicle management platform based on the first request message.

15. The device of claim 11, wherein the first sending module further comprises:
a second sending sub-module that is configured to send the flight information of the unmanned aerial vehicle to a currently accessed base station of the unmanned aerial vehicle and/or an accessible base station of the unmanned aerial vehicle, wherein the accessible base station of the unmanned aerial vehicle is a base station capable to be accessed when the unmanned aerial vehicle flies based on the flight path.

16. The device of claim 11, wherein the first sending module further comprises:
a third receiving sub-module that is configured to receive a second request message sent by the base station, wherein the second request message carries identification information of the unmanned aerial vehicle;
a third sending sub-module that is configured to return the flight information corresponding to the identification information of the unmanned aerial vehicle to the base station sending the second request message.

17. A device for transmitting flight information of an unmanned aerial vehicle that is applied to a base station, the device comprising:
a second acquisition module that is configured to acquire a base station list corresponding to the unmanned aerial vehicle from a core network device; and
a determination module that is configured to return flight information corresponding to identification information of the unmanned aerial vehicle to a base station sending a second request message.

18. The device of claim 17, wherein the second acquisition module further comprises:
a fourth sending sub-module that is configured to send the second request message to the core network device, wherein the second request message carries the identification information of the unmanned aerial vehicle; and
a fourth receiving sub-module that is configured to receive the flight information corresponding to the identification information of the unmanned aerial vehicle returned by the core network device based on the second request message.

19. The device of claim 17, wherein the determination module further comprises:
a fifth sending sub-module that is configured to send a third request message for acquiring base station location information to an adjacent base station if the flight information includes a flight path of the unmanned aerial vehicle;
a fifth receiving sub-module that is configured to receive the base station location information returned by the adjacent base station based on the third request message; and
a first determination sub-module that is configured to determine a base station with the base station location information matched with the flight path as a next accessible base station to which the unmanned aerial vehicle is handed over.

20. The device of claim 17, wherein the determination module further comprises:
a second determination sub-module that is configured to determine a next accessible base station to which the unmanned aerial vehicle is handed over based on an accessible base station recorded in the base station list if the flight information includes the base station list corresponding to the unmanned aerial vehicle.
